(19) United States
(12) Patent Application Publication
(10) Pub. No.: US 2025/0175106 A1
(43) Pub. Date: May 29, 2025

(54) MOTOR CONTROL DEVICE AND METHOD FOR SEMICONDUCTOR PROCESS EQUIPMENT

(71) Applicants: SEMES CO., LTD., Cheonan-si (KR); IUCF-HYU (Industry-University Cooperation Foundation Hanyang University), Seoul (KR)

(72) Inventors: Chan Young CHOI, Cheonan-si (KR); Dong Bock LEE, Cheonan-si (KR); Dae Hee WON, Cheonan-si (KR); Ju LEE, Seoul (KR); In Yeol YUN, Seoul (KR); Hyun Woo KIM, Seoul (KR); Jung Ho AHN, Suwon-si (KR)

(73) Assignees: SEMES CO., LTD., Cheonan-si (KR); IUCF-HYU (Industry-University Cooperation Foundation Hanyang University), Seoul (KR)

(21) Appl. No.: 18/962,065

(22) Filed: Nov. 27, 2024

(30) Foreign Application Priority Data
Nov. 27, 2023 (KR) 10-2023-0167117

(51) Int. Cl. H02P 23/00

(52) U.S. Cl. CPC H02P 23/0004

(57) ABSTRACT

Disclosed are a motor control device and method for semiconductor process equipment, more particularly a motor control technology for semiconductor process equipment capable of applying a line drive type signal processing technique to determine an error of an operation signal of a motor and compensating for the error to perform sensorless control of the motor.

### CROSS-REFERENCE TO THE RELATED APPLICATION

The present application claims priority to and the benefit of Korean Patent Application No. 10-2023-0167117, filed on Nov. 27, 2023, in the Korean Intellectual Property Office, the entire disclosure of which is incorporated herein by reference.

### BACKGROUND

### 1. Field

Embodiments of the present disclosure relate to a motor control device and method for semiconductor process equipment, and more particularly to a motor control technology for semiconductor process equipment capable of applying a line drive type signal processing technique to determine an error of an operation signal of a motor and compensating for the error to perform sensorless control of the motor.

### 2. Description of the Related Art

Semiconductors may be manufactured through eight major processes: a wafer process, an oxidation process, a photolithography process, an etching process, a thin film deposition process, a wiring process, a testing process, and a packaging process.

Detailed steps are performed for each process, and a plurality of devices for carrying out the processes is linked to constitute semiconductor process equipment.

Since a semiconductor manufacturing process is carried out in the ultra-fine scale of nanometers, each device needs to be precisely controlled accordingly.

Each device that performs the semiconductor manufacturing process uses a plurality of motors to perform a process operation.

However, as a motor rotates at high speeds, it is difficult to obtain accurate data due to the effects of noise and signal delay caused by inductance.

Conventionally, as the motor rotates at high speeds, the processing speed of the inductance component of the motor and control data is lowered, resulting in a decrease in responsiveness. For example, when controlling the motor using a current control algorithm, a delay of a current signal occurs as the speed of the motor increases, which causes reverse torque to be applied to a permanent magnet synchronous motor that requires a current command to be applied according to the position of a rotor of the motor. This leads to a reduction in efficiency and torque of the motor, making accurate control difficult.

In particular, even if the algorithm to control the motor is changed to a reverse electromotive force-based algorithm, harmonics and distortion of a waveform make it difficult to detect the exact position of the rotor, which reduces the reliability in operation of the motor.

Sensorless control based on such inaccurate data is unable to follow the exact position, which leads to a decrease in the output and efficiency of the motor, and if errors are continuously accumulated, the motor may seriously lose controllability and malfunction.

### SUMMARY

The present disclosure has been made in view of the above problems, and it is an object of the present disclosure to provide a scheme for reducing an error generated when sensorless control of a permanent magnet synchronous motor driven at high speeds is performed.

In particular, sensorless control based on such inaccurate data is unable to follow the exact position, which leads to a decrease in the output and efficiency of the motor, and if errors are continuously accumulated, the motor may seriously lose controllability and malfunction. It is another object of the present disclosure to solve the above problems.

The objects of the present disclosure are not limited to the aforementioned objects, and other unmentioned objects and advantages will be clearly understood by a person having ordinary skill in the art to which the present disclosure pertains based on the following description.

In accordance with an aspect of the present disclosure, the above and other objects can be accomplished by the provision of a motor control method for semiconductor process equipment, the motor control method including a motor operation feedback step of applying a control signal to a motor and receiving a resulting operation signal as feedback to obtain a feedback operation signal, a component signal generation step of generating a normal component signal and a reverse component signal for the feedback operation signal, and an error determination step of determining an error of the feedback operation signal with respect to a normal operation signal of the motor in response to the control signal based on the reverse component signal.

The component signal generation step may include generating a normal component signal, which is a true reflection of the feedback operation signal, and generating a reverse component signal, which is an inversion of the feedback operation signal.

In one example, the component signal generation step may include generating a normal component signal and a reverse component signal through a differential signal with respect to the feedback operation signal.

The error determination step may include adding reverse component signal to the normal operation signal to determine the error of the feedback operation signal.

In one example, the error determination step may include adding the reverse component signal to the normal operation signal to generate an error signal.

The motor control method may further include an operation signal compensation step of determining a compensation component for the normal component signal based on the error and compensating for the feedback operation signal based on the compensation component.

In one example, the operation signal compensation step may include regarding the error as the compensation component for the feedback operation signal, combining the compensation component with the normal component signal to generate a compensation signal, and compensating for the feedback operation signal based on the compensation signal.

The motor control method may further include an operation signal compensation step of adding the error signal to the normal component signal to generate a compensation signal and compensating for the feedback operation signal based on the compensation signal.

The motor control method may further include an operation signal storage step of storing the normal operation signal of the motor according to the application of the control signal.

In accordance with another aspect of the present disclosure, there is provided a motor control device for semiconductor process equipment that performs a semiconductor process, wherein the motor control device applies a control signal to a motor of the semiconductor process equipment to control the operation of the motor, receives an operation signal of the motor corresponding to the control signal as feedback to obtain a feedback operation signal, generates a normal component signal and a reverse component signal for the feedback operation signal through line drive type signal processing, determines an error of the feedback operation signal with respect to a normal operation signal of the motor in response to the control signal based on the reverse component signal, and compensates for the error to control the motor.

The motor control device may include a motor controller configured to apply a control signal to the motor to control the operation of the motor and to receive an operation signal of the motor corresponding to the control signal as feedback to obtain a feedback operation signal and an operation signal compensator configured to generate a normal component signal and a reverse component signal for the feedback operation signal through line drive type signal processing, to determine an error of the feedback operation signal with respect to a normal operation signal of the motor in response to the control signal based on the reverse component signal, and to determine a compensation component for the normal component signal based on the error to compensate for the feedback operation signal.

The operation signal compensator may include a signal extraction unit configured to generate a normal component signal, which is a true reflection of the feedback operation signal, and a reverse component signal, which is an inversion of the feedback operation signal, and an error determination unit configured to add the reverse component signal to the normal operation signal of the motor corresponding to the control signal to determine the error of the feedback operation signal.

In one example, the signal extraction unit may generate a normal component signal and a reverse component signal through a differential signal with respect to the feedback operation signal.

In one example, the error determination unit may add the reverse component signal to the normal operation signal to generate an error signal.

The operation signal compensator may further include a signal compensation unit configured to determine a compensation component for the normal component signal based on the error and to compensate for the feedback operation signal based on the compensation component.

In one example, the operation signal compensator may regard the error as the compensation component for the feedback operation signal, combine the compensation component with the normal component signal to generate a compensation signal, and compensate for the feedback operation signal based on the compensation signal.

In one example, the operation signal compensator may add the error signal to the normal component signal to generate a compensation signal and compensate for the feedback operation signal based on the compensation signal.

The signal extraction unit may have the normal operation signal of the motor according to the application of the control signal.

The motor control device may individually control a plurality of motors provided in the semiconductor process equipment to obtain feedback operation signals, generate a component signal through line drive type signal processing for each of the feedback operation signals, and compensate for an error of an operation signal of each of the motors based thereon.

In accordance with a further aspect of the present disclosure, there is a motor control method for semiconductor process equipment, the motor control method including a motor operation feedback step of applying a control signal to a motor and receiving a resulting operation signal as feedback to obtain a feedback operation signal, a component signal generation step of generating a normal component signal, which is a true reflection of the feedback operation signal, and a reverse component signal, which is an inversion of the feedback operation signal, through a differential signal with respect to the feedback operation signal, an error determination step of adding the reverse component signal to a normal operation signal of the motor in response to the control signal to determine an error of the feedback operation signal and adding the reverse component signal to the normal operation signal to generate an error signal, and an operation signal compensation step of regarding the error as a compensation component for the feedback operation signal, adding the error signal to the normal component signal to generate a compensation signal, and compensating for the feedback operation signal based on the compensation signal.

### BRIEF DESCRIPTION OF THE DRAWINGS

The accompanying drawings, which are incorporated in this specification, illustrate exemplary embodiments and serve to further illustrate the technical ideas of the present disclosure in conjunction with the detailed description of exemplary embodiments that follows, and the present disclosure is not to be construed as limited to what is shown in such drawings. In the drawings:

FIG. 1 is a conceptual view showing the flow of a semiconductor manufacturing process;

FIGS. 2 and 3 are block diagrams showing an embodiment of a motor control device according to the present disclosure;

FIG. 4 is a block diagram showing an embodiment of an operation signal compensator of the motor control device according to the present disclosure;

FIG. 5 is a block diagram showing the operation of the embodiment of the operation signal compensator of the motor control device according to the present disclosure;

FIG. 6 is a flowchart showing an embodiment of a motor control method according to the present disclosure;

FIG. 7 is a flowchart showing an embodiment of compensating for an error of an operation signal by applying line drive type signal processing in the motor control method according to the present disclosure;

FIG. 8 is a view showing an operation process of the embodiment of the motor control method according to the present disclosure;

FIG. 9 is a view showing an example of controlling a motor by applying the present disclosure; and

FIG. 10 is a view showing an example of compensating for an operation error of the motor by applying the present disclosure.

### DETAILED DESCRIPTION OF EXEMPLARY EMBODIMENTS

Hereinafter, preferred embodiments of the present disclosure will be described in detail with reference to the accompanying drawings, but the present disclosure is not limited or restricted by the embodiments.

In order to describe the present disclosure, operational advantages of the present disclosure, and objects achieved by practicing the present disclosure, preferred embodiments of the present disclosure will hereinafter be illustrated and a description will be given with reference thereto.

First, it should be noted that the terminology used in the present application is used only to describe specific embodiments and is not intended to limit the present disclosure, and singular forms are intended to include plural forms unless mentioned otherwise. It should also be understood that in the present application, the terms “including” or “having” and the like are intended to designate the presence of the features, numbers, steps, operations, components, parts, or combinations thereof described in the specification, and not to preclude the possibility of the presence or addition of one or more other features, numbers, steps, operations, components, parts, or combinations thereof.

In describing the present disclosure, a detailed description of known configurations or functions incorporated herein will be omitted when the same may obscure the subject matter of the present disclosure.

The present disclosure presents a technology of controlling a permanent magnet synchronous motor of semiconductor process equipment.

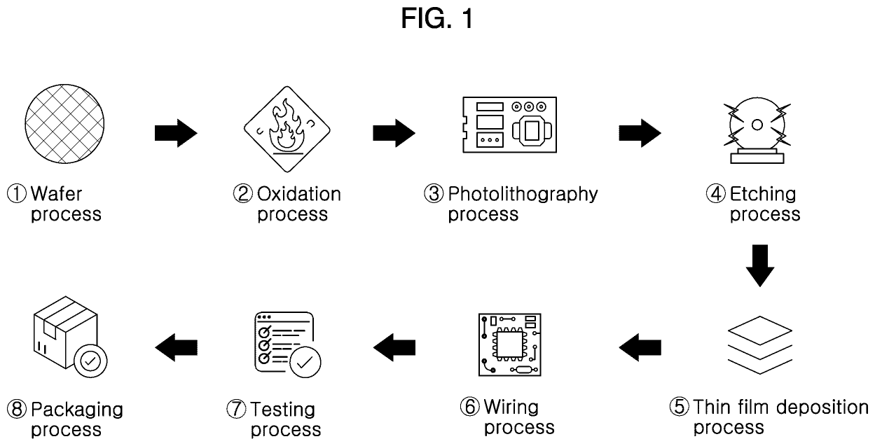

FIG. 1 is a conceptual view showing the flow of semiconductor manufacturing process.

The semiconductor manufacturing process includes eight major processes. The eight major processes are a wafer process, an oxidation process, a photolithography process, an etching process, a thin film deposition process, a metal wiring process, an electrical die sorting (EDS) process, and a packaging process, which are sequentially performed.

The wafer process is a process of manufacturing a wafer, which is a material used to manufacture a semiconductor integrated circuit. A round disk wafer having silicon as the main component is manufactured through the wafer process.

The oxidation process is a process of forming an oxide film on the surface of the wafer, wherein oxygen or water vapor is chemically reacted with the surface of the silicon wafer at a high temperature of 800 degrees to 1200 degrees to form a thin and uniform silicon oxide film.

The oxidation process may be performed to protect the surface of the wafer from impurities generated from various contaminants and chemicals generated during the semiconductor manufacturing process.

The photolithography process is a process of printing electronic circuit patterns on the wafer using light. The photolithography process is performed in the sequence of photoresist application, exposure, and development.

The etching process is a process of removing unnecessary parts other than the electronic circuit patterns printed through the photolithography process. The etching process is performed as dry etching or wet etching depending on the situation.

The thin film deposition process is a process of depositing an insulating film such that, when a multilayered circuit layer is formed by lamination on the wafer that has been subjected to the etching process, the circuit layers do not affect each other. Physical vapor deposition or chemical vapor deposition is used as a deposition method.

The metal wiring process is a process of electrically connect the formed electronic circuit patterns to each other.

The electrical die sorting process is a process of inspecting electrical quality of each chip formed on the wafer.

The packaging process is a process of sawing and packaging a plurality of chips formed on the wafer.

Through these processes, semiconductor chip products may be completed, and various devices are used for each process. Semiconductor process equipment is equipped with a large number of motors, and precise control of the motors is required when performing the process, and if there is an error in control, defective products are generated and the yield is reduced.

As one of the motors applied to semiconductor process equipment, a permanent magnet synchronous motor is a motor that is operated with reluctance torque and magnetic torque.

When controlling the motor, the position and speed of a rotor are measured and the operation of the motor is controlled based thereon. Sensors that measure the position and speed of the rotor are affected by changes in the surrounding environment. For example, the performance of the sensor decreases depending on ambient temperature, humidity, and vibration of the sensing location, whereby a sensing error occurs. In order to solve such a problem, a sensorless control method is utilized.

When the sensorless control method is used, there is a problem that the back electromotive force component of the rotor is too small in a low-speed rotation area, making it difficult to accurately predict the position of the rotor. In addition, there is a problem that, in a high-speed rotation area, accurate sensing is difficult due to a signal delay phenomenon caused by noise effects and inductance.

The present disclosure proposes a scheme capable of accurately determining and compensating for errors caused in the low-speed rotation area and the high-speed rotation area.

In particular, the present disclosure presents a motor control technology for semiconductor process equipment capable of performing sensorless control by applying a line drive type signal processing technique to determine an error of an operation signal of the motor and compensate for the error.

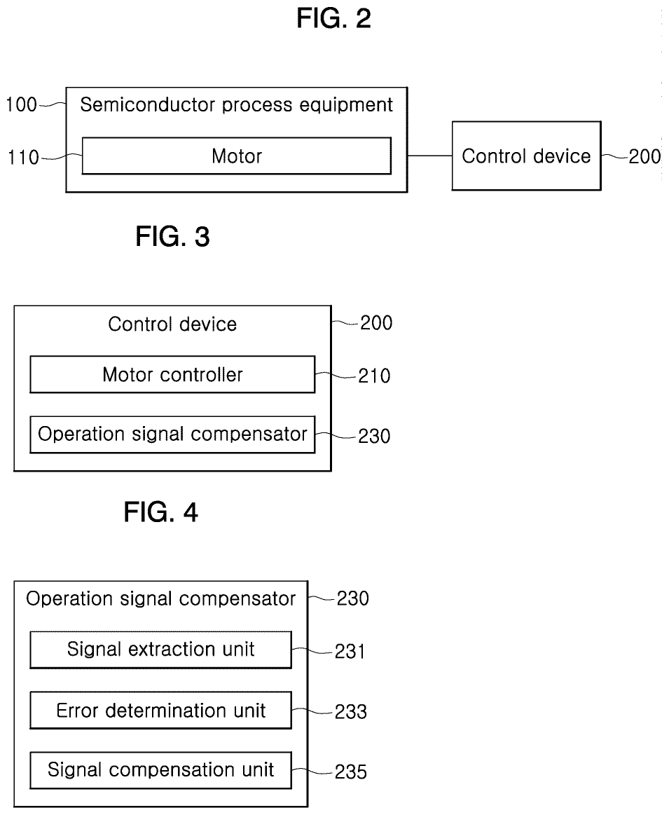

FIGS. 2 and 3 are block diagrams showing an embodiment of a motor control device according to the present disclosure.

In semiconductor process equipment 100, a motor 110 is disposed to perform a process, and the motor 110 may be precisely controlled by a control device 200. A plurality of motors 110 may be disposed in the semiconductor process equipment 100, and one control device 200 may individually control the motors 110.

The control device 200 may apply a line drive signal processing technique to control the motor 110.

The control device 200 may include a motor controller 210 and an operation signal compensator 230.

The motor controller 210 may apply a control signal to the motor 110 to operate the motor 110, may receive an operation signal according to the operation of the motor 110 as feedback, and may provide the operation signal to the operation signal compensator 230. The motor controller 210 may control the motor 110 based on compensation of the operation signal by the operation signal compensator 230.

The operation signal compensator 230 may determine an error of the feedback operation signal and may compensate for and provide the operation signal based on the error determination result. Preferably, the operation signal compensator 230 applies a line drive signal processing technique to determine the error of the operation signal and to compensate for the operation signal accordingly.

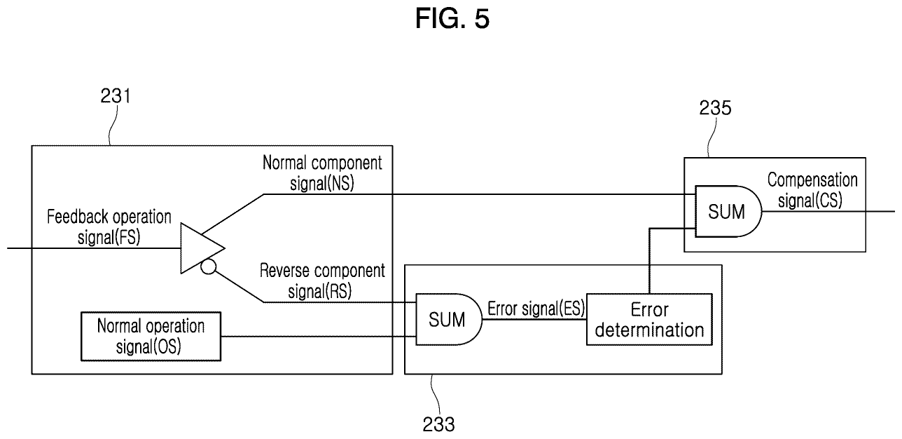

FIG. 4 is a block diagram showing an embodiment of the operation signal compensator of the motor control device according to the present disclosure, and FIG. 5 is a block diagram showing the operation of the embodiment of the operation signal compensator of the motor control device according to the present disclosure.

The operation signal compensator 230 may include a signal extraction unit 231, an error determination unit 233, and a signal compensation unit 235.

The signal extraction unit 231 may receive a feedback operation signal FS for the motor to be controlled from the motor controller 210 and may generate component signals NS and RS for the operation signal. Here, the component signals for the operation signal may include a normal component signal NS and a reverse component signal RS.

In one example, the signal extraction unit 231 may apply a line drive signal processing technique to generate the normal component signal NS and the reverse component signal RS through a differential signal with respect to the feedback operation signal.

The error determination unit 233 may determine an error for the operation signal. In one example, the error determination unit 233 may sum the reverse component signal RS and a normal operation signal OS, may generate an error signal ES for the error, and may determine an error for the feedback operation signal FS based thereon. Here, the normal operation signal (OS) may be a signal obtained as a result of simulation of the normal operation of the motor according to the control signal or a signal obtained from the repeated normal operation of the motor.

The signal compensation unit 235 may generate a compensation signal CS by compensating for the feedback operation signal FS based on the error determination result of the error determination unit 233. In one example, the signal compensation unit 235 may generate the compensation signal CS by summing the normal component signal NS and the error signal ES for the error.

In the above embodiment, the control device 200 was described as including the operation signal compensator 230, which may be a separate component of the device, but preferably the operation signal compensator 230 is implemented as a program through an algorithm and installed on the motor controller 210.

In the present disclosure, as described above, it is possible to perform control such that the motor follows normal operation by compensating for a distorted waveform caused by the error of the operation signal through the control device having the line drive signal processing technique applied thereto.

Furthermore, the semiconductor process equipment may be equipped with a plurality of motors, and the control device 200 may individually control the plurality of motors to obtain feedback operation signals, may generate a component signal through line drive type signal processing for each of the feedback operation signals, and may compensate for an error of the operation signal of each of the motors based thereon.

The present disclosure also provides a method of controlling the motor through the motor control device described above, and hereinafter, a motor control method according to the present disclosure will be described with reference to an embodiment.

Since the motor control method according to the present disclosure is implemented through the motor control device according to the present disclosure described above, reference will be made to the embodiment of the motor control device described above.

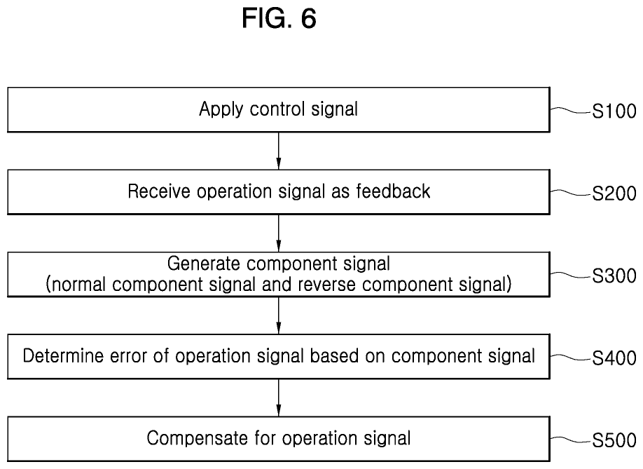

FIG. 6 is a flowchart showing an embodiment of the motor control method according to the present disclosure.

The control device 200 may control the motor 110 of the semiconductor process equipment 100 by applying a control signal to the motor 110 of the semiconductor process equipment 100 (S100).

The control device 200 may obtain an operation signal of the motor 110 according to the control signal through feedback (S200).

The control device 200 may analyze the feedback operation signal to generate a component signal (S300). Preferably, the control device 200 generates a normal component signal and a reverse component signal for the feedback operation signal, and determines an error for the operation signal based on the component signals (S400).

The control device 200 may regard the determined error as a compensation component for the feedback operation signal, and may generate a compensation signal by combining the compensation component with the normal component signal, and may compensate for the feedback operation signal based on the compensation signal (S500).

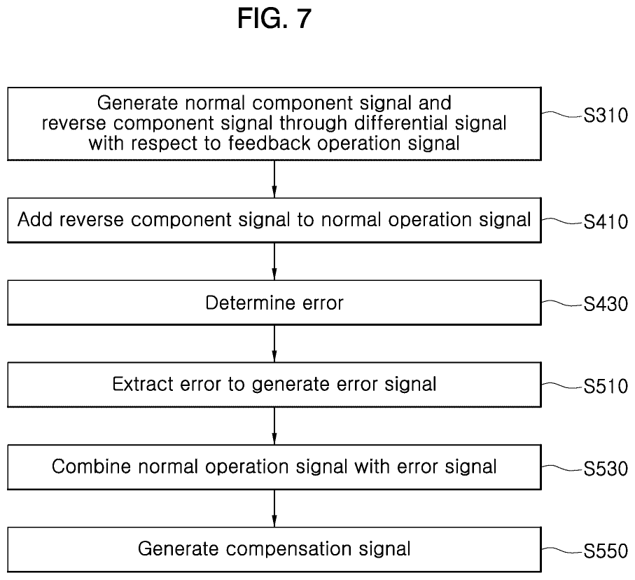

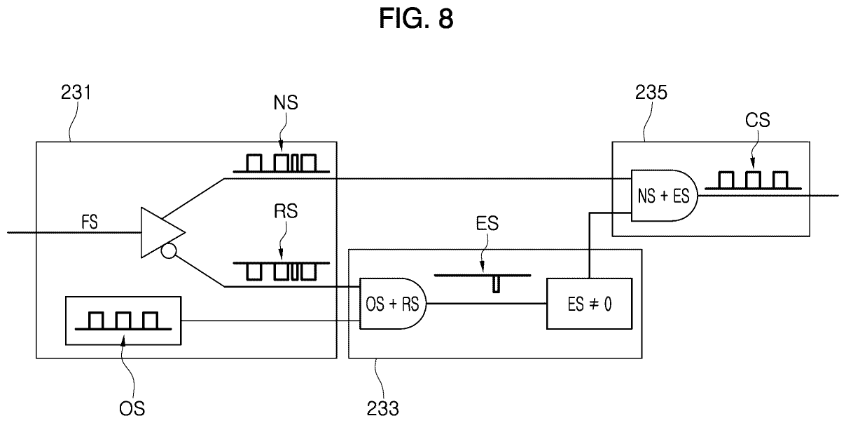

In particular, the motor control method according to the present disclosure applies a line drive signal processing technique to determine an error of the operation signal and compensates for the error to perform sensorless control of the motor, which will be described in more detail with reference to embodiments of FIGS. 7 and 8.

FIG. 7 is a flowchart showing an embodiment of compensating for an error of the operation signal by applying the line drive type signal processing to the motor control method according to the present disclosure, and FIG. 8 is a view showing an operation process of the embodiment of the motor control method according to the present disclosure.

The signal extraction unit 231 of the operation signal compensator 230 may generate a normal component signal NS and a reverse component signal RS through a differential signal with respect to a feedback operation signal FS (S310). In one example, the signal extraction unit 231 may generate a normal component signal NS, which is a true reflection of the feedback operation signal FS, and a reverse component signal RS, which is an inversion of the feedback operation signal FS. Preferably, the signal extraction unit 231 generates a normal component signal NS and a reverse component signal RS through a differential signal with respect to the feedback operation signal FS.

The error determination unit 233 of the operation signal compensator 230 may add the reverse component signal RS to a normal operation signal OS (S410), and may determine an error based on the result of addition (S430). Here, the normal operation signal OS is a signal obtained as a result of simulation of the normal operation of the motor according to a control signal or obtained from the repeated normal operation of the motor, and the signal extraction unit 231 may store and retain the normal operation signal OS corresponding to the control signal.

For example, if addition of the reverse difference signal RS to the normal operation signal OS results in a signal that is consistently zero in magnitude or consistently maintains a magnitude within a set range, the error determination unit 233 may determine that there is no error in the feedback operation signal FS. If addition of the reverse difference signal RS to the normal operation signal OS results in a magnitude exceeding a set value in a specific part, the error determination unit 233 may determine that an error is present in that part.

The error determination unit 233 may generate an error signal ES based on the determination result of the error (S510). In one example, the error determination unit 233 may add the reverse difference signal RS to the normal operation signal OS to generate the error signal ES.

The signal compensation unit 235 of the operation signal compensator 230 may combine the normal component signal with the error signal (S530) to generate a compensation signal (S550).

Since an error is determined based on the reverse component signal RS with respect to the feedback signal FS and an error signal ES having the error is generated, the error signal ES may be a signal in which the error of the normal component signal NS is inverted.

Therefore, the signal compensation unit 235 may generate a compensation signal CS with the error removed from the normal component signal NS by adding the error signal ES to the normal component signal NS.

In the present disclosure, as described above, it is possible to determine the error for the feedback operation signal and to reflect the compensation component corresponding to the error for compensation such that a distorted signal waveform is compensated for and is controlled so as to follow the normal signal.

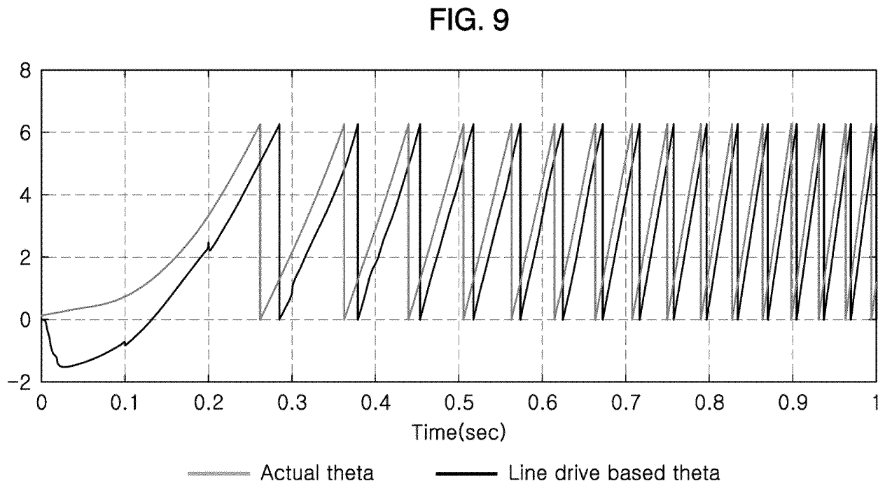

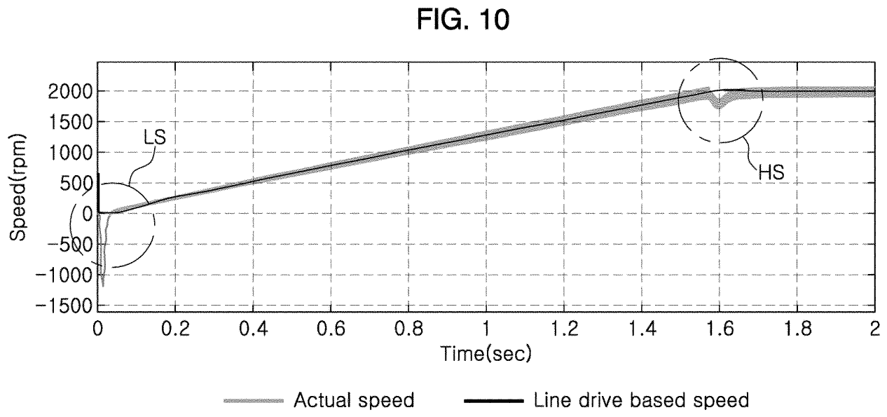

FIG. 9 is a view showing an example of controlling a motor by applying the present disclosure, and FIG. 10 is a view showing an example of compensating for an operation error of the motor by applying the present disclosure.

FIG. 9 shows theta (AT) according to the operation of a motor to which the present disclosure is not applied and theta (LT) according to the operation of a motor to which the present disclosure is applied. FIG. 10 shows the rotational speed of the motor to which the present disclosure is not applied and the rotational speed of the motor to which the present disclosure is applied.

In the present disclosure, a distorted waveform may be compensated for by applying the line drive type signal processing described above to determine the magnitude and position of the error and compensate therefor.

In particular, conventionally, in the low-speed rotation area LS of the motor, the position of the rotor is not accurately predicted, making it difficult to control the motor to follow the normal operation, but in the present disclosure, it is possible to stably control the motor to follow the normal operation in the low-speed rotation area LS. In addition, conventionally, in the high-speed rotation area HS of the motor, accurate sensing is not performed due to a signal delay phenomenon caused by noise effects and inductance, resulting in an error in the operation of the motor, but, in the present disclosure, it is possible to control the motor to follow the normal operation according to a control signal.

As is apparent from the above description, according to the present disclosure, it is possible to prevent an error that occurs when sensorless control of a permanent magnet synchronous motor driven at high speed is performed.

Particularly, in the present disclosure, it is possible to minimize loss by determining the magnitude and position of an error of an operation signal by line drive type signal processing and compensating for the error based on a compensation component.

Furthermore, in the present disclosure, it is possible to improve accuracy and reliability of motor control by compensating for an error in a low-speed rotation area and a high-speed rotation area of the motor to follow an accurate position value of sensorless control.

The effects of the present disclosure are not limited to the aforementioned effects, and other unmentioned effects will be clearly understood by a person having ordinary skill in the art to which the present disclosure pertains from the above description.

The above description is merely an exemplary description of the technical ideas of the present disclosure, and a person having ordinary skill in the art to which the present disclosure pertains will be able to make various modifications and variations without departing from the essential features of the present disclosure. Therefore, the embodiments of the present disclosure are intended to illustrate, not to limit, the technical ideas of the present disclosure, and the technical ideas of the present disclosure are not limited by the embodiments. The scope of protection of the present disclosure shall be construed in accordance with the following claims, and all technical ideas within the scope thereof shall be construed as falling within the scope of right of the present disclosure.

What is claimed is:

1. A motor control method for semiconductor process equipment, the motor control method comprising:
a motor operation feedback step of applying a control signal to a motor and receiving a resulting operation signal as feedback to obtain a feedback operation signal;
a component signal generation step of generating a normal component signal and a reverse component signal for the feedback operation signal; and
an error determination step of determining an error of the feedback operation signal with respect to a normal operation signal of the motor in response to the control signal based on the reverse component signal.

2. The motor control method as claimed in claim 1, wherein the component signal generation step comprises generating a normal component signal, which is a true reflection of the feedback operation signal, and generating a reverse component signal, which is an inversion of the feedback operation signal.

3. The motor control method as claimed in claim 1, wherein the component signal generation step comprises generating a normal component signal and a reverse component signal through a differential signal with respect to the feedback operation signal.

4. The motor control method as claimed in claim 1, wherein the error determination step comprises adding the reverse component signal to the normal operation signal to determine the error of the feedback operation signal.

5. The motor control method as claimed in claim 4, wherein the error determination step comprises adding the reverse component signal to the normal operation signal to generate an error signal.

6. The motor control method as claimed in claim 1, further comprising an operation signal compensation step of determining a compensation component for the normal component signal based on the error and compensating for the feedback operation signal based on the compensation component.

7. The motor control method as claimed in claim 6, wherein the operation signal compensation step comprises regarding the error as the compensation component for the feedback operation signal, combining the compensation component with the normal component signal to generate a compensation signal, and compensating for the feedback operation signal based on the compensation signal.

8. The motor control method as claimed in claim 5, further comprising an operation signal compensation step of adding the error signal to the normal component signal to generate a compensation signal and compensating for the feedback operation signal based on the compensation signal.

9. The motor control method as claimed in claim 1, further comprising an operation signal storage step of storing the normal operation signal of the motor according to the application of the control signal.

10. A motor control device for semiconductor process equipment that performs a semiconductor process, wherein the motor control device applies a control signal to a motor of the semiconductor process equipment to control an operation of the motor, receives an operation signal of the motor corresponding to the control signal as feedback to obtain a feedback operation signal, generates a normal component signal and a reverse component signal for the feedback operation signal through line drive type signal processing, determines an error of the feedback operation signal with respect to a normal operation signal of the motor in response to the control signal based on the reverse component signal, and compensates for the error to control the motor.

11. The motor control device as claimed in claim 10, wherein the motor control device comprises:
a motor controller configured to apply a control signal to the motor to control the operation of the motor and to receive an operation signal of the motor corresponding to the control signal as feedback to obtain a feedback operation signal; and
an operation signal compensator configured to generate a normal component signal and a reverse component signal for the feedback operation signal through line drive type signal processing, to determine an error of the feedback operation signal with respect to a normal operation signal of the motor in response to the control signal based on the reverse component signal, and to determine a compensation component for the normal component signal based on the error to compensate for the feedback operation signal.

12. The motor control device as claimed in claim 11, wherein the operation signal compensator comprises:
a signal extraction unit configured to generate a normal component signal, which is a true reflection of the feedback operation signal, and a reverse component signal, which is an inversion of the feedback operation signal; and
an error determination unit configured to add the reverse component signal to the normal operation signal of the motor corresponding to the control signal to determine the error of the feedback operation signal.

13. The motor control device as claimed in claim 12, wherein the signal extraction unit generates a normal component signal and a reverse component signal through a differential signal with respect to the feedback operation signal.

14. The motor control device as claimed in claim 12, wherein the error determination unit adds the reverse component signal to the normal operation signal to generate an error signal.

15. The motor control device as claimed in claim 12, wherein the operation signal compensator further comprises a signal compensation unit configured to determine a compensation component for the normal component signal based on the error and to compensate for the feedback operation signal based on the compensation component.

16. The motor control device as claimed in claim 15, wherein the operation signal compensator regards the error as the compensation component for the feedback operation signal, combines the compensation component with the normal component signal to generate a compensation signal, and compensates for the feedback operation signal based on the compensation signal.

17. The motor control device as claimed in claim 14, wherein the operation signal compensator adds the error signal to the normal component signal to generate a compensation signal and compensates for the feedback operation signal based on the compensation signal.

18. The motor control device as claimed in claim 12, wherein the signal extraction unit has the normal operation signal of the motor according to the application of the control signal.

19. The motor control device as claimed in claim 10, wherein the motor control device individually controls a plurality of motors provided in the semiconductor process equipment to obtain feedback operation signals, generates a component signal through line drive type signal processing for each of the feedback operation signals, and compensates for an error of an operation signal of each of the motors based thereon.

20. A motor control method for semiconductor process equipment, the motor control method comprising:
a motor operation feedback step of applying a control signal to a motor and receiving a resulting operation signal as feedback to obtain a feedback operation signal;
a component signal generation step of generating a normal component signal, which is a true reflection of the feedback operation signal, and a reverse component signal, which is an inversion of the feedback operation signal, through a differential signal with respect to the feedback operation signal;
an error determination step of adding the reverse component signal to a normal operation signal of the motor in response to the control signal to determine an error of the feedback operation signal and adding the reverse component signal to the normal operation signal to generate an error signal; and
an operation signal compensation step of regarding the error as a compensation component for the feedback operation signal, adding the error signal to the normal component signal to generate a compensation signal, and compensating for the feedback operation signal based on the compensation signal.
